(19) United States
(12) Patent Application Publication
(10) Pub. No.: US 2009/0145984 A1
(43) Pub. Date: Jun. 11, 2009

(54) PUSH BUTTON WHEREIN THE DISPENSING CHAMBER IS FORMED BETWEEN A BODY AND AN ADDED COVER

(76) Inventors: Bernard Clerget, Haudivilliers (FR); Jean-Pierre Songbe, Saint Pierre En Val (FR); Herve Imenez, Mons Boubert (FR)

Correspondence Address: ST. ONGE STEWARD JOHNSTON & REENS, LLC, 986 BEDFORD STREET, STAMFORD, CT, 06905-5619, US

(21) Appl. No.: 12/330,040

(22) Filed: Dec. 8, 2008

(30) Foreign Application Priority Data
Dec. 11, 2007 (FR) 07 08646

(51) Int. Cl. F02M 61/00

(52) U.S. Cl. 239/533.12

(57) ABSTRACT

An actuating push button of a dispensing system of a liquid, that includes a body and a dispensing chamber in communication with a shaft which is formed in said body to pump the liquid, said chamber being provided with at least one orifice for the dispensing of the pumped liquid, said push button including an added cover which is associated to the body with the upper wall of said body arranged across from the lower wall of said cover, a cavity being formed on at least one of these walls in such a way as to form the dispensing chamber between said walls.

### CROSS-REFERENCE TO RELATED APPLICATIONS

The present application claims priority of French patent application No. 07 08646 filed on Dec. 11, 2007, the content of which is incorporated herein by reference.

### FIELD OF THE INVENTION

The invention relates to an actuating push button of a dispensing system of a liquid as well as such a dispensing system.

### BACKGROUND OF THE INVENTION

In a particular application, the dispensing system is intended to equip bottles utilised the perfume industry, in cosmetics or for pharmaceutical treatments. Indeed, this type of bottle contains a liquid which is restored by a dispensing system comprising a pump or a manual actuation valve, said system being actuated by a push button in order to allow the spraying of the liquid.

Such push buttons are conventionally produced in two or three portions: an actuator body, a spray nozzle for the liquid and possibly a trim covering said body, said portions being assembled in relation to one another to form the push button. In particular, the spraying nozzle can be arranged to form an aerosol with the liquid, especially when provided with a dispensing chamber termed vortex.

After assembly of the different portions, the push button has a dispensing chamber in communication with a shaft which is formed in the body, said chamber being provided with at least one dispensing orifice. As such, by mounting the shaft on the dispensing system, in particular on the nozzle of such a system, it is possible to dispense the liquid by manual axial pressure on the push button.

However, this assembly limits the possibilities of producing the dispensing chamber for the conveyance and the treatment of the stream of liquid. In particular, it is not possible to produce two dispensing orifices of converging axes in one point located in a perfectly determined plan and which can be reproduced industrially at a high rate.

Also know are, in particular for the dispensing of viscous liquids, push buttons produced as a single part in order to integrate the dispensing chamber. However, since these parts are produced by moulding, the arrangements of the accessible chambers are limited by the constraints of removing from the mould.

The purpose of the invention is to resolve the problems of prior art by proposing in particular a push button which is produced in two portions wherein between the dispensing chamber is formed, in such a way as to increase the possibilities of producing said chamber, in particular by moulding.

### SUMMARY OF THE INVENTION

To that effect, and according to a first aspect, the invention proposes an actuating push button of a dispensing system of a liquid, said push button comprising a body and a dispensing chamber in communication with a shaft which is formed in said body to pump the liquid, said chamber being provided with at least one dispensing orifice of the pumped liquid, said push button comprising an added cover which is associated to the body with the upper wall of said body arranged across from the lower wall of the cover, a cavity being formed on at least one of these walls in such a way as to form the dispensing chamber between said walls.

According to a second aspect, the invention proposes a dispensing system of a liquid comprising a pump or a manual actuation valve wherein the shaft of such a push button is mounted in order to allow for the dispensing of the liquid through at least one orifice.

### BRIEF DESCRIPTION OF THE DRAWINGS

Other purposes and advantages of the invention shall appear in the description that follows, made in reference to the annexed figures wherein:

FIG. 1 is a perspective exploded view of a push button according to a first embodiment of the invention;

FIG. 2 is a longitudinal section view of the push button of FIG. 1, said button being shown in an assembly position on the nozzle of a pump mounted on the neck of a bottle;

FIG. 3 are views of a push button according to a second embodiment of the invention, respectively as an exploded perspective (FIG. 3a) and as a longitudinal section (FIG. 3b);

FIG. 4 are views of a push button according to a third embodiment of the invention, respectively as an exploded perspective (FIG. 4a) and as a longitudinal section (FIG. 4b).

### DETAILED DESCRIPTION OF THE INVENTION

In the description, the terms of positioning in space are taken in reference to the axes of the different parts forming the push button.

In relation with the figures, a dispensing push button, in particular spraying, of a dispensing system of a liquid, is described hereinbelow, said liquid able to be of any type, especially used in the perfume industry, in cosmetics or for pharmaceutical treatments.

The push button comprises an actuator body 1 having, in a single unit, an external skirt 2 and an internal skirt 3, said skirts extend under an upper wall 4 with said internal skirt surrounded by said external skirt. The internal skirt 3 delimits a mounting housing 5 of the push button on the dispensing system. The housing 5 is in communication with a shaft 6 which is formed axially in the body 1 to pump the liquid in a dispensing chamber 7 in communication with said shaft, said chamber being provided with at least one dispensing orifice 8 of the pumped liquid.

In FIG. 2, the dispensing system has a nozzle G which is inserted in a sealed manner in the housing 5. In a known way, the dispensing system further comprises means for assembling on the neck C of a bottle containing the liquid and means for taking T of the liquid inside of bottle which is arranged to supply the nozzle G with liquid under pressure.

For that, the dispensing system comprises a manually actuated pump P or, in the case where the liquid is packaged under pressure in the bottle, a manual actuation valve. As such, during a manual movement of the push button, the pump P or the valve is actuated to supply the nozzle G with liquid under pressure.

The push button also comprises an added cover 9 that substantially has the same rotating cylindrical casing as the body 1, said cover being associated on the body 1 in such a way as to form a unitary actuating part of the dispensing system. Furthermore, the push button can include a trim for aspect, for example made of anodised or tinted aluminium, which is mounted on the cover 9 and/or on the body 1, by covering the upper wall 10 of cover 9 and/or the exterior face of the external skirt 2 while leaving free the dispensing orifice 8.

The body 1 and the cover 9 can be produced by moulding of a plastic material, in particular in the same material or in two similar materials, and be assembled by welding or by gluing. The weld can be of the ultrasonic or high frequency type. The materials can be of the polyolefin type, for example polypropylene or polyethylene.

The cover 9 comprises an upper wall 10 making it possible for the user to exert on it a digital pressure in order to be able to axially and jointly move the body 1, and therefore allow the actuation of the dispensing system via an axial pressure on the push button. The cover 9 also has a lower wall 11 which is arranged across from the upper wall 4 of the body 1 in order to allow for the association of said cover on said body.

The dispensing chamber 7 is formed between the upper 4 and lower 11 walls by the formation of a cavity 12 on at least one of these walls 4, 11, the dispensing orifice 8 being arranged on the periphery of the push button for a lateral dispensing of the liquid.

In the embodiments shown, the cavity 12 is formed as a recess in the lower wall 11 of the cover 9, the portion of the upper wall 4 which is arranged across from the cavity 12 being plane. As such, the dispensing chamber 7 is delimited in the upper portion by the portion of the lower wall 11 whereon is formed the bottom of the cavity 12, and in the lower portion by the plane wall 4 wherein the shaft 6 exits. However a cavity 12 can be provided on the upper wall 4 of the body 1 or a cooperation of cavities formed respectively on one of these walls 4, 11.

This production of the dispensing chamber 7 in two portions by means of a cover 9 and of a body 1 which are associated after manufacture and relative orientation according to their common axis, makes it possible to limit the constraints of removing from the mould in such a way as to increase the possibilities of producing said chamber.

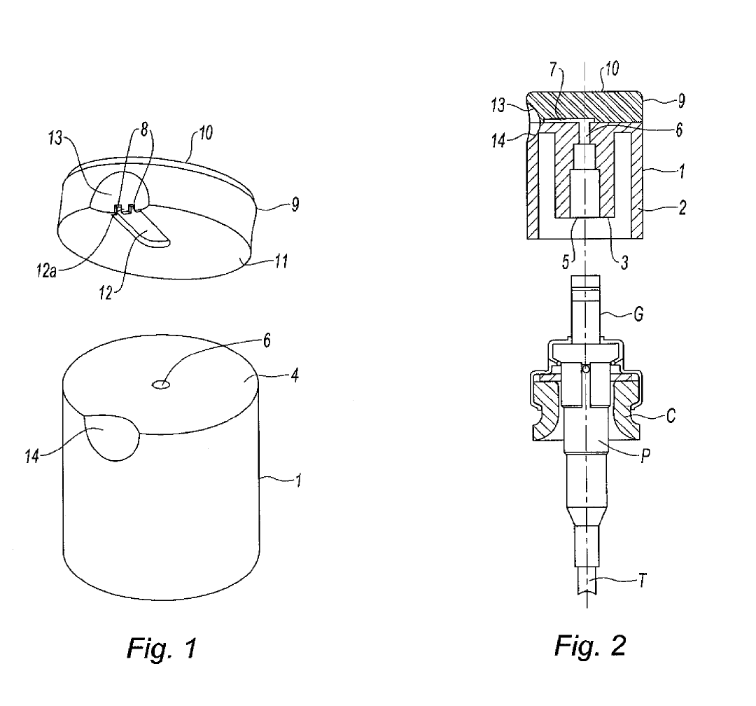

In particular, as shown in FIGS. 1 to 3, it is possible to produce two dispensing orifices 8 according to respectively one axis, the orientation relative of the axes of dispensing being convergent in order to form a zone of intersection of the portions of liquid which are dispensed through an orifice 8. This production makes it possible to generate streams of liquid which explode into microdroplets during their collision in the zone of intersection.

In these figures, the dispensing orifices 8 are formed on the exterior edge 12a of the cavity 12 which is arranged downstream of the dispensing chamber 7. More precisely, each orifice 8 is formed by a notch in the exterior wall 12a, said orifices being delimited in the upper portion by the bottom of the cavity 12 and in the lower portion by the plane wall 4. Furthermore, the exterior edge 12a has a concave profile and the dispensing orifices 8 are arranged symmetrically along said profile is such a way as to orient their dispensing axis.

Moreover, the exterior edge 12a is arranged as a recess on the periphery of the push button in such a way as to form a housing 13 at the bottom of which the dispensing orifice 8 is formed. More precisely, the housing 13 is formed on the edge of the cover 9 in the continuity of the lower wall 11.

Furthermore, the housing 13 is extended on the upper wall 4 by the formation of an additional recess 14 on the edge of the body 1, the bottom of said recess being arranged in the extension of the exterior edge 12a. In FIGS. 1 to 3, the housing 13 has a spherical geometry. In function of the relative orientation of the dispensing axes of orifices 8, it can be arranged that the zone of intersection be arranged inside or outside of the housing 13.

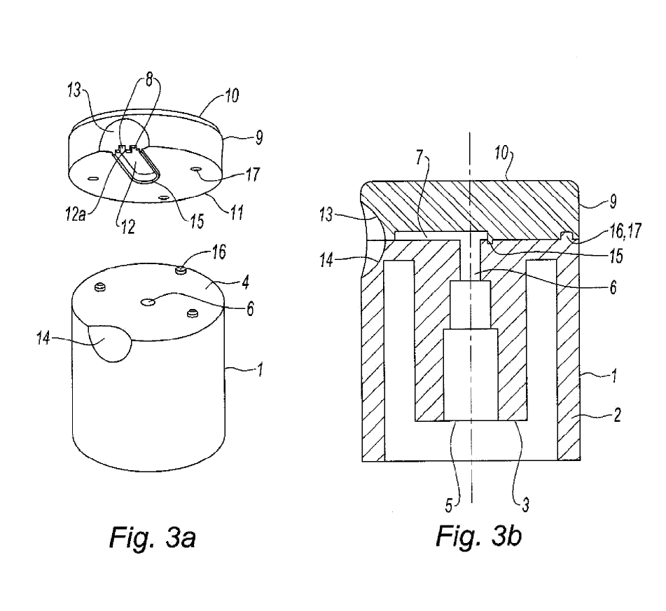

In FIG. 3, the edge of the cavity 12 is provided with a bead seal 15 protruding towards the upper wall 4, said bead being a tight press against the plane upper wall 4, in such a way as to improve the seal of the dispensing chamber 7.

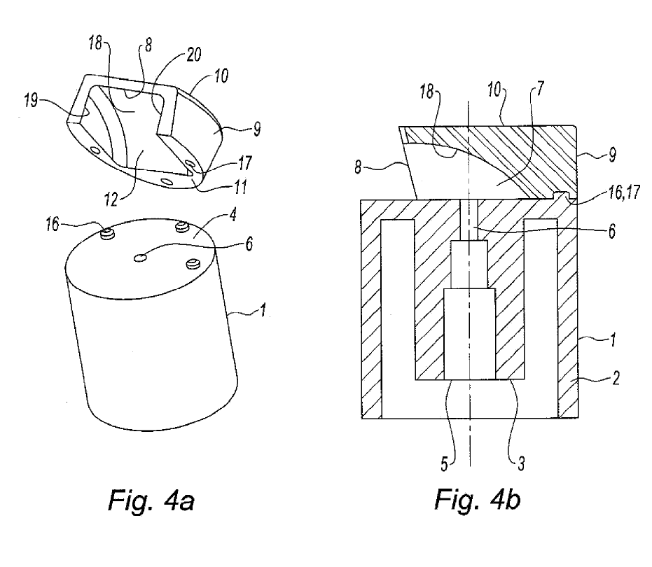

Furthermore, the walls 4, 11 can be provided with means of angular positioning and/or associating of the cover 9 on the body 1. In the figures 3 and 4, these means include three studs 16 formed on the upper wall 4 and three recesses 17 formed on the lower wall 11. Each stud 16 is received in a recess 17 in an angular position defined between the cover 9 and the body 1, the association able to be produced by clamping or by engagement of the studs 16 in the recesses 17.

These productions without welding of gluing the cover 9 on the body 1 making it possible to assemble the parts of different materials, for example in a flexible material such as polypropylene for the body 1 and in rigid material such as polyoxymethylene (POM), cyclic olefin copolymers (COC) or poly(butylene terephthalate) (PBT) for the cover 9, in order to provide a proper engagement as well as good geometric accuracy in the production of the cavity 12 and in particular the orifices 8. Furthermore, the materials may be of a different colour, aspect or feel for aesthetic effects or improved ergonomics.

Advantageously, the studs 16 can be made from the most rigid material and the recesses 17 from the most flexible material in order to avoid planing of the studs and to favour their imbrication via creeping into the recesses 17.

In FIGS. 4, the cavity 12 has a curved surface 18 which is formed as a recess in the lower wall 11, said surface being oriented towards the shaft 6 in such a way as to form a deflector of the liquid between said shaft and the dispensing orifice 8. As such, the deflector makes it possible to explode into microdroplets the liquid jet exiting at high speed from the shaft 6, said microdroplets being guided towards the orifice 8 along the curved surface 18.

More precisely, in the FIGS. 4, the cavity 12 has two lateral edges 19, 20 extending axially on either side of the shaft 6, the curved surface 18 being formed between said edges. Furthermore, the curved surface 18 extends from the interface between the walls 4, 11 towards the periphery of the push button, the orifice 8 being delimited laterally by said lateral edges.

1. An actuating push button of a dispensing system of a liquid, said push button comprising a body and a dispensing chamber in communication with a shaft which is formed in said body to pump the liquid, said chamber being provided with at least one orifice for the dispending of the pumped liquid, said push button being characterised in that it comprises an added cover which is associated to the body with the upper wall of said body arranged across from the lower wall of said cover, a cavity being formed on at least one of these walls in such a way as to form the dispensing chamber between said walls.

2. The push button set forth in claim 1, characterised in that the orifice is arranged on the periphery of the push button for a lateral dispensing of the liquid.

3. The push button set forth in claim 1, characterised in that the cavity is produced as a recess on one of the walls, the portion of the other wall which is arranged across from the cavity being plane.

4. The push button set forth in claim 3, characterised in that the edge of the cavity is provided with a bead seal which is arranged as a tight press against the plane wall.

5. The push button as set forth in claim 1, characterised in that the dispensing orifice is formed in the exterior edge of the cavity.

6. The push button set forth in claim 5, characterised in that it comprises two dispensing orifices according to respectively one axis, the relative orientation of the axes of said dispensing orifices being arranged to form a zone of intersection of the portions of liquid which are dispensed through respectively one orifice.

7. The push button set forth in claim 6, characterised in that the exterior edge has at least one concave profile, the dispensing orifices being arranged symmetrically along said profile in such a way as to orient their dispensing axis.

8. The push button as set forth in claim 5, characterised in that the exterior edge is arranged as a recess on the periphery of the push button, in such a way as to form a housing at the bottom of which the dispensing orifice is formed.

9. The push button set forth in claim 8, characterised in that the housing is extended in the other wall by the formation of an additional recess of which the bottom is arranged in the extension of the exterior edge.

10. The push button as set forth in claim 1, characterised in that the cavity has a curved surface which is oriented towards the shaft in such a way as to form a deflector of the liquid between said shaft and the dispensing orifice.

11. The push button set forth in claim 10, characterised in that the cavity has two lateral edges between which is formed the curved surface (18), said curved surface extending from the interface between the walls towards the periphery of the push button, the orifice being delimited laterally by said lateral edges.

12. The push button as set forth in claim 1, characterised in that the walls are provided with means of angular positioning and/or of associating of the cover and of the body.

13. The push button set forth in claim 12, characterised in that the means include studs and recesses in which each therein respectively receives a stud.

14. A dispensing system of a liquid comprising a pump or a manual actuation valve on which a shaft of a push button is mounted in order to allow for the dispensing of the liquid through at least one orifice, wherein said push button comprises a body and a dispensing chamber in communication with the shaft which is formed in said body to pump the liquid, said chamber being provided with at least one orifice for the dispending of the pumped liquid, said push button being characterised in that it comprises an added cover which is associated to the body with the upper wall of said body arranged across from the lower wall of said cover, a cavity being formed on at least one of these walls in such a way as to form the dispensing chamber between said walls.
